(19) United States
(12) Patent Application Publication
(10) Pub. No.: US 2009/0320644 A1
(43) Pub. Date: Dec. 31, 2009

(54) Torque Limiter for Engine Starter

(75) Inventors: Peter K. Farrar, Indianapolis, IN (US); David L. Durant, Anderson, IN (US); Balazs Palfai, Fishers, IN (US)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: REMY INTERNATIONAL, INC., Pendleton, IN (US)

(21) Appl. No.: 12/165,098

(22) Filed: Jun. 30, 2008

(51) Int. Cl. F02N 15/10; F02N 1/00

(52) U.S. Cl. 74/7 C; 74/7 E

(57) ABSTRACT

An engine starter comprises a housing with a planetary gear arrangement provided within the housing. The planetary gear arrangement includes a ring gear configured to pivot about an axis. The ring gear includes a face oriented substantially perpendicular to the axis, the face including a plurality of detents provided as a plurality of ribs and a plurality of depressions on the face. A torque limiter is positioned adjacent to the face of the ring gear within the housing of the engine starter. The torque limiter includes a plurality of projecting members engaging the plurality of detents on the ring gear when the ring gear pivots about the axis. The torque limiter is provided as a plate including a central hole, a body portion, and a perimeter portion. The plurality of projecting members comprise a plurality of spring fingers extending from the body portion at an angle.

### FIELD

This application relates to the field of engine starters, and more particularly to torque absorbing or limiting components in an engine starter.

### BACKGROUND

Many engine starters include a planetary gear system that transmits power from an electric starter motor to a pinion configured to engage an engine ring gear. The planetary gear system typically includes a sun gear connected to the output shaft of the electric motor. A plurality of planet gears revolve around the ring gear. The planet gears also engage teeth provided on an outer ring gear in the planetary gear system.

Engine starters may encounter excessive torque in the radial direction of the output shaft of the starter. For example, the torque associated with initial rotation of the electric motor, a slow turning pinion, or a jammed pinion may all result in excessive torque to the planetary gear system. When the planetary gear system encounters excessive torque, the planet gears may grind against the teeth of the outer ring gear. After time, the teeth of the planet gears grinding against the teeth of the ring gear may result in excessive wear or even failure of the planetary gear system.

In view of the foregoing, it would be advantageous to provide an engine starter having torque absorbing features provided in association with the planetary gear system of the starter. It would also be advantageous if such torque absorbing features could be easily incorporated into the engine starter.

### SUMMARY

An engine starter comprises a housing with a planetary gear arrangement provided within the housing. The planetary gear arrangement includes a ring gear configured to pivot about an axis. The ring gear includes a face oriented substantially perpendicular to the axis, the face including a plurality of detents provided as a plurality of ribs and a plurality of depressions on the face. An output shaft is connected to the planetary gear arrangement such that the planetary gear arrangement is configured to drive the output shaft. A pinion provided on the output shaft.

A torque limiter is positioned adjacent to the face of the ring gear within the housing of the engine starter. The torque limiter includes a plurality of projecting members engaging the plurality of detents on the ring gear when the ring gear pivots about the axis. The torque limiter is provided as a plate including a central hole, a body portion, and a perimeter portion. The plurality of projecting members comprise a plurality of spring fingers extending from the body portion at an angle. The plurality of spring fingers are provided as cut out portions of the body portion such that an opening is provided in the body portion in association with each of the plurality of spring fingers. The plurality of spring fingers each include a end tip portion that is bent away from the rest of the spring finger such that the end tip portion is generally parallel to the main body portion.

The above described features and advantages, as well as others, will become more readily apparent to those of ordinary skill in the art by reference to the following detailed description and accompanying drawings. Furthermore, while it would be desirable to provide an engine starter that includes one or more of the foregoing or other advantageous features as may be apparent to those reviewing this disclosure, the teachings disclosed herein extend to those embodiments which fall within the scope of the appended claims, regardless of whether they include the above-mentioned features accomplish or provide one or more of the above-mentioned advantages.

### BRIEF DESCRIPTION OF THE DRAWINGS

FIG. 1 shows a cutaway view of an embodiment of an engine starter having a torque limiter;

FIG. 2 shows a perspective view of a ring gear of a planetary gear mechanism of the engine starter of FIG. 1;

FIG. 3 shows a perspective view of a ring gear side of a torque limiter configured to engage the ring gear of FIG. 2; and

FIG. 4 shows a perspective view of the opposite side of the torque limiter of FIG. 3.

### DESCRIPTION

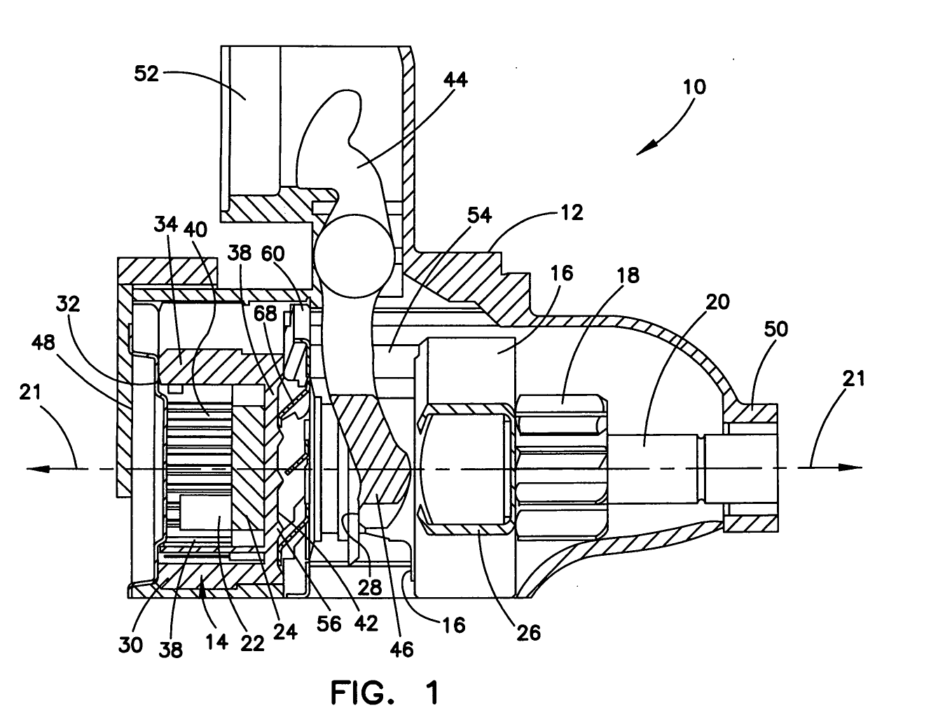

With reference to FIG. 1, an electric engine starter or cranking motor 10 is illustrated. The starter 10 is provided in a housing 12. The housing 12 includes a solenoid chamber 52 which encloses a solenoid (not shown). The housing 12 also includes a drive chamber 54, which encloses an electric motor (not shown), a planetary gear system 14, an overrunning clutch 16 and a pinion gear 18. The overrunning clutch 16 and the pinion gear 18 are both provided upon a pinion drive shaft 20.

The electric motor provided within the housing 12 is a direct current motor. The direct current motor includes an armature and an armature shaft. The motor further has a means for developing field flux (also not illustrated) which may take the form of a plurality of permanent magnets.

The armature shaft of the direct current motor is connected to the sun gear (not shown) of the planetary gear mechanism 14. The sun gear is provided at the center of the planetary gear mechanism 14 along the same axis 21 as the pinion drive shaft 20. A plurality of planet gears (not shown) are positioned about and engage the sun gear. Each of the planet gears is provided on a post 22. The posts 22 holding the planet gears are connected to a rotatable platform 24 which, in turn, is connected to the pinion drive shaft 20. The planet gears rotate about the sun gear within a ring gear 30.

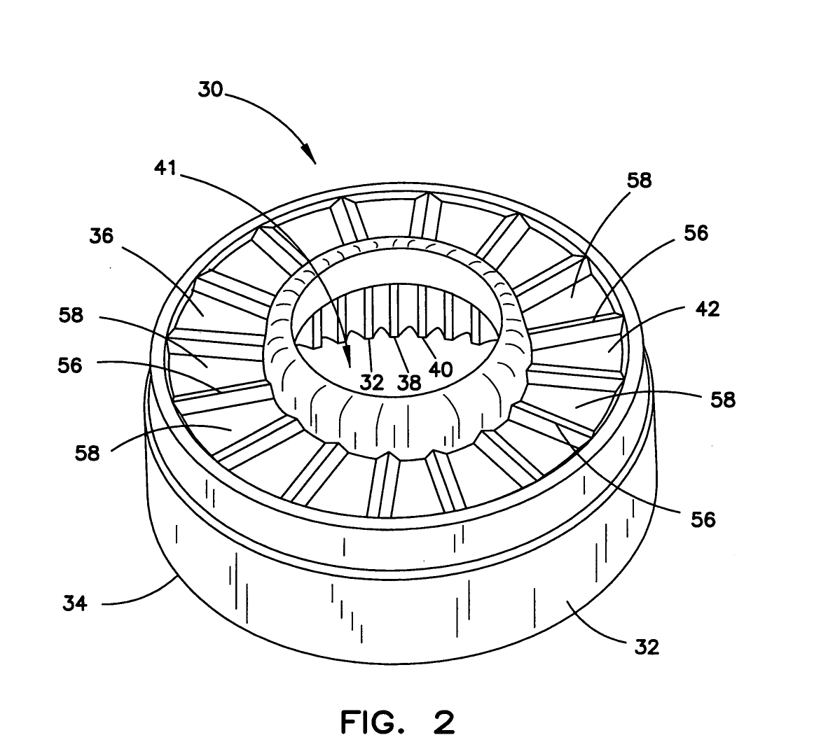

With reference now to FIGS. 1 and 2, the ring gear 30 generally cylindrical or cup-shaped. The ring gear 30 includes an open rear end 32, a circular sidewall 34, and a forward face 36. The open rear end 32 is positioned on the electric motor side of the ring gear and abuts a metal plate 48 positioned within the housing 12. The output shaft 20 of the electric motor passes through the metal plate 48 and into the interior of the ring gear 30 to engage the sun gear.

A torque limiter 60 is provided adjacent to the ring gear 30 on the pinion-side of the ring gear 30. Accordingly, the forward face 36 of the ring gear 30 abuts the torque limiter 60. As explained in further detail below, the torque limiter 60 is provided as a plate comprising a plurality of spring fingers. The spring fingers engage detents 42 on the forward face 36, allowing the ring gear to rotate slightly in the radial direction about the axis 21 (i.e., in a circular direction about the axis 21). As best seen in FIG. 2, the detents 42 are provided as a plurality of elongated radial ribs 56 formed upon the forward face 36. A recess or depression 58 is provided between each pair of ribs 56. Each rib 56 is generally smooth and rounded such that a smooth rounded contour is provided when moving across the rib 56 from one depression 58 to the next.

The interior portion of the ring gear 30 includes a planetary gear track 38 including a plurality of teeth 40 provided on the interior surface of the circular sidewall 34. The teeth of the planet gears engage the teeth 40 of the planetary gear track 38 and the planet gears circle the planetary gear track 38 as they rotate about the sun gear.

The rotatable platform 24 is rotatably positioned within the ring gear 30. In particular, as the planet gears rotate, the posts 22 holding the planet gears also rotate. Because the posts 22 are connected to the platform 24, the platform 24 also rotates with the planet gears. As shown in FIG. 2, the ring gear 30 includes a hole 41 in its front face. The platform 24 is connected to the pinion drive shaft 20 through this hole 41. Accordingly, rotation of the platform 24 results in rotation of the pinion drive shaft 20.

The shaft 20 drives a starter drive that is comprised of the overrunning clutch 16 and a pinion gear 18. The pinion gear 18 is adapted to be moved into mesh with the ring gear of an engine. The shell 26 of the overrunning clutch has a helical splined connection to the shaft 20, which is not illustrated. During operation of the starter motor, after the engine fires and the pinion begins to rotate at excessive speeds, the overrunning clutch prevents translation of this excessive speed back to the planetary gear mechanism 14 and the electric motor.

The housing 12 includes an end nose portion 50. The nose portion 50 has an access opening (not shown) which allows the pinion gear 18 to be moved into mesh with a ring gear of an engine.

The housing 12 also includes a solenoid chamber or compartment 52. A solenoid (not shown) is held within the solenoid chamber 52. The plunger of the solenoid engages a shift lever 44 which extends between the solenoid chamber 52 and the drive housing 54. The shift lever 44 includes arms 46 that extend from an end portion and engage the overrunning clutch 16. It can be appreciated that when shift lever 44 is pivoted in the counter-clockwise direction by action of the solenoid in the solenoid chamber, the arms 46 will engage surface of the clutch 16 to push the overrunning clutch 16 and pinion 18 to the right, in FIG. 1, to a position where pinion 18 will mesh with the ring gear of the engine. Likewise, solenoid action against the shift lever causing clockwise movement of shift lever 44 causes surface 28 to be engaged by the arms 46 of the shift lever 44, thereby causing the pinion 18 to be pulled out of mesh with the engine ring gear.

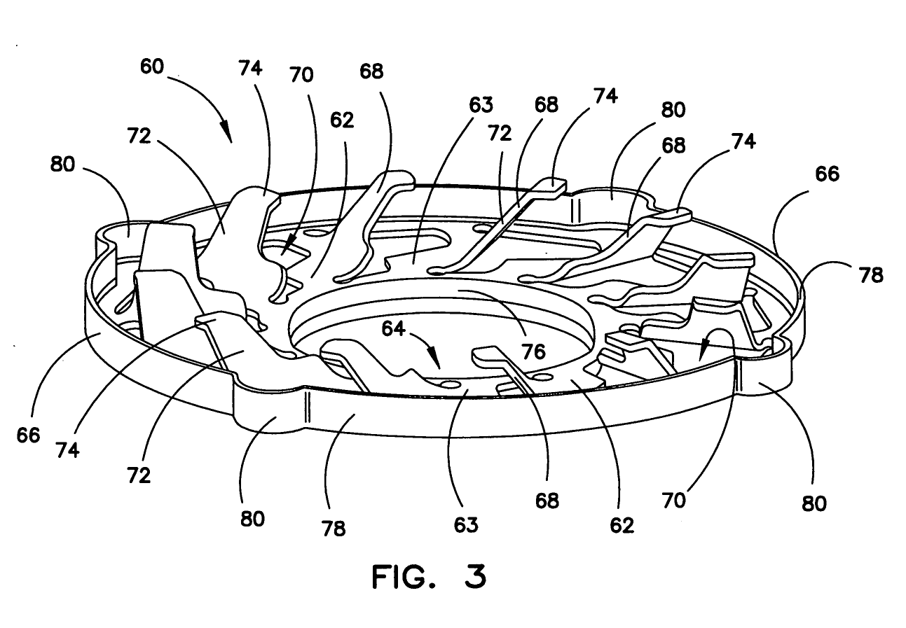

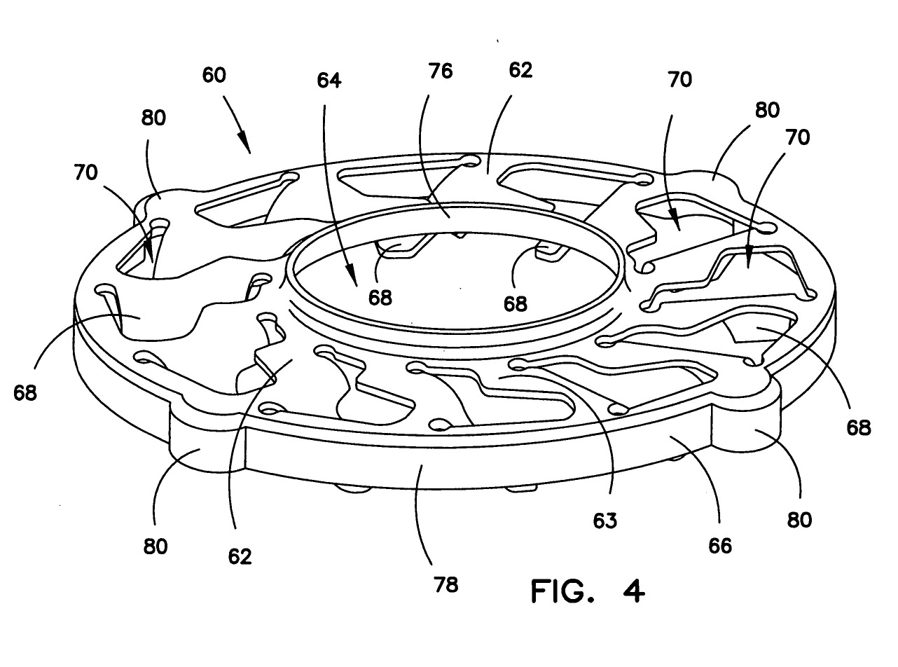

With reference now to FIGS. 3 and 4, a more detailed view of the torque limiter 60 is shown. The torque limiter 60 is generally provided as a metal plate comprising a body portion 62, a central hole 64, and a perimeter portion 66.

The body portion 62 of the torque limiter includes a generally flat surface 63 provided within a body plane. A plurality of projecting members 68 extend from the body portion 66 and engage the plurality of detents 42 on the ring gear. In the embodiment of FIGS. 3 and 4, the plurality of projecting members 68 are provided as spring fingers 68 which extend from the flat surface 63 of the body portion 62 at an angle. In one embodiment, the spring fingers 68 extend from the flat surface 63 of the body portion 62 at an angle between 30° and 60° relative to the body plane. The spring fingers 68 may be formed by stamping the fingers out of the flat surface 63 of the body portion and bending the fingers away from the flat surface at an angle. Accordingly, an opening 70 may be provided in the body portion 62 in association with each of the spring fingers 68. In particular, the openings 70 are formed in the area in the body portion 62 where the spring fingers 68 were cut out of the flat surface 63.

Each of the spring fingers 68 includes an elongated portion 72 and an integral end tip portion 74. The end tip portion 74 is provided on the end of the spring finger 68 that is most distant from the flat surface 63. The end tip portion 74 angles away from the elongated portion 72 of the spring finger such that the end tip portion 74 is generally parallel to the flat surface 63 of the body portion 62. This angled relationship between the end tip portion 74 and the elongated portion 72 may be provided by bending the end tip portion 74 on the elongated portion 76 when the spring finger 68 is bent away from the flat surface 63 of the body portion 62. As shown in FIG. 1, the end tip portions 74 of the spring fingers 68 contact the detents 42 in the ring gear 30, holding the ring gear in place within the housing. In particular, with reference to FIGS. 2 and 3, the end tip portions 74 extend into the depressions 58 and abut the ribs 56 on the face 36 of the ring gear.

Returning to FIGS. 3 and 4, the central hole 64 of the torque limiter 60 is defined by an interior lip that extends from the flat surface 63. The central hole is configured to provide a passage between the rotatable platform 24 of the planetary gear mechanism 14 and the output shaft 20 of the engine starter 10, allowing the output shaft 20 to be connected to the planetary gear mechanism 14.

The perimeter portion 66 of the torque limiter 60 includes an outer lip 78 that extends around the perimeter of the torque limiter 60. A plurality of tabs 80 are provided on the outer lip 78 in the form of rounded knobs. These knobs 80 are configured to engage slots or recesses formed in the housing 12. The slots in the housing are also rounded and complimentary in shape to the knobs 80. Accordingly, when the knobs 80 are fitted into the slots in the housing 12, the knobs secure the torque limiter 60 in place within the housing 12, preventing the torque limiter 60 from rotating about the axis 21.

In operation of the engine starter 10, when the ring gear 30 is exposed to excessive torque, the torque limiter 60 provides a dampening feature for the ring gear, limiting wear to the teeth 40 of the ring gear 30. In particular, when the ring gear experiences excessive torque, the forces of the planet gears against the ring gear encourage the ring gear 30 to pivot about the axis 11. The degree of ring gear 30 pivot within the housing is dependent upon the amount of torque encountered by the ring gear. In particular, when the ring gear 30 begins to rotate about the axis 21, the ribs 56 on the face 36 of the ring gear 30 are forced against the spring fingers 68 of the torque limiter 60. As the spring fingers 68 ride up the contoured surface of the ribs 56, the spring fingers 68 flex back toward the flat surface 63 of the torque limiter body portion 62. This force provided by the spring fingers 68 against the ribs 56 of the ring gear 30 increases as the spring fingers flex. When the ring gear 30 is exposed to sufficient torque, the ring gear 30 rotates such that the spring fingers 68 slide completely past the ribs and into the next subsequent depression 58 on the ring gear This rotation action by the ring gear 30 provides a torque dampening feature for the engine starter, allowing the planetary gear system to minimize wear caused by excessive torque events. When the excessive torque is removed, the ring gear 30 remains in the last incremental orientation encountered during the excessive torque event, with the spring fingers 68 sliding down into the closest depressions 58 on the ling gear.

Although the present invention has been described with respect to certain preferred embodiments, it will be appreciated by those of skill in the art that other implementations and adaptations are possible. Moreover, there are advantages to individual advancements described herein that may be obtained without incorporating other aspects described above. Therefore, the spirit and scope of the appended claims should not be limited to the description of the preferred embodiments contained herein.

What is claimed is

1. An engine starter comprising:
a housing;
a planetary gear arrangement provided within the housing, the planetary gear arrangement including a ring gear, the ring gear including a plurality of detents; and
a plate positioned adjacent to the ring gear within the housing, the plate including a plurality of fingers, the plurality of fingers engaging the detents in the ring gear.

2. The engine starter of claim 1 wherein the ring gear is cup shaped and includes a face on a pinion side of the ring gear, and wherein the detents are provided in the face of the ring gear.

3. The engine starter of claim 1 wherein the detents comprise a plurality of ribs on a face of the ring gear.

4. The engine starter of claim 1 wherein the plate is formed from a single piece of metal.

5. The engine starter of claim 1 wherein the plate comprises a perimeter with a plurality of tabs extending from the perimeter, the plurality of tabs positioned in recesses formed in the housing.

6. The engine starter of claim 1 wherein the plate includes a body portion arranged in a body plane and the plurality of fingers extend at an angle from the body portion away from the body plane.

7. The engine starter of claim 6 wherein each of the plurality of fingers include an end tip portion that is bent upon the end of the finger such that the end tip portion is substantially parallel to the body plane.

8. The engine starter of claim 6 wherein the plurality of finger extend away from the body portion at an angle between 30° and 60° relative to the body plane.

9. The engine starter of claim 6 wherein the plate is comprised of metal and the plurality of fingers are removed from the body portion such an opening is provided in the body portion in association with each of the plurality of fingers.

10. A torque limiter configured to engage a ring gear in a planetary gear arrangement of an engine starter provided within a housing, the torque limiter comprising:
a plate member including a perimeter, a central hole, and a main body portion provided between the central hole and the perimeter;
a plurality of tabs integrally formed on the perimeter of the plate member; and
a plurality of spring fingers integrally formed on the main body portion, the plurality of spring fingers extending outward from the main body portion at an angle.

11. The torque limiter of claim 10 wherein the plurality of tabs are configured to engage recesses formed in the housing.

12. The torque limiter of claim 10 wherein the main body portion includes a flat surface and the plurality of spring fingers are provided as cut out portions of the flat surface of the main body portion such that an opening is provided in the flat surface of the main body portion in association with each of the plurality of spring fingers.

13. The torque limiter of claim 12 wherein the plurality of spring fingers each include a end tip portion that is bent away from the rest of the spring finger such that the end tip portion is generally parallel to the flat surface of the main body portion.

14. An engine starter comprising:
a housing;
a planetary gear arrangement provided within the housing, the planetary gear arrangement including a ring gear configured to pivot about an axis, the ring gear including a face oriented substantially perpendicular to the axis, the face including a plurality of detents provided as a plurality of ribs and a plurality of depressions on the face;
an output shaft connected to the planetary gear arrangement such that the planetary gear arrangement is configured to drive the output shaft;
a pinion provided on the output shaft; and
a torque limiter positioned adjacent to the face of the ring gear, the torque limiter including a plurality of projecting members engaging the plurality of detents on the ring gear when the ring gear pivots about the axis.

15. The engine starter of claim 14 wherein the torque limiter is provided as a plate including a central hole, a body portion, and a perimeter portion.

16. The torque limiter of claim 15 wherein the plurality of projecting members comprise a plurality of spring fingers extending from a flat surface of the body portion at an angle.

17. The torque limiter of claim 16 wherein the plurality of spring fingers are provided as cut out portions of the flat surface of the body portion such that an opening is provided in the flat surface of the body portion in association with each of the plurality of spring fingers.

18. The torque limiter of claim 17 wherein the plurality of spring fingers each include a end tip portion that is bent away from the rest of the spring finger such that the end tip portion is generally parallel to the flat surface of the body portion.

19. The torque limiter of claim 18 wherein the central hole provides passage to the output shaft, and wherein the perimeter portion includes a plurality of tabs configured to engage recesses formed in the housing.
